(19) United States
(12) Patent Application Publication
(10) Pub. No.: US 2017/0041403 A1
(43) Pub. Date: Feb. 9, 2017

(54) SYSTEM, METHOD AND COMPUTER PROGAM PRODUCT FOR PAIRING COMPUTING DEVICES FOR COMMUNICATION

(71) Applicant: TOHTT SERVIÇOS DE TECNOLOGIA LTDA, Pernambuco (BR)

(72) Inventors: John-Paul Gignac, LaSalle (CA); Tarcisio de Meira Lins Filho, Recife (BR)

(21) Appl. No.: 15/228,571

(22) Filed: Aug. 4, 2016

Related U.S. Application Data
(60) Provisional application No. 62/259,271, filed on Nov. 24, 2015.
(60) Provisional application No. 62/200,842, filed on Aug. 4, 2015.

(51) Int. Cl. H04L 29/08; H04L 29/06

(52) U.S. Cl. CPC H04L 67/141; H04L 67/146; H04L 67/143; H04L 67/104; H04L 69/16

(57) ABSTRACT

Methods and systems are provided for periodic acknowledgments embedded in the data streams, in particular, for pairing computing devices for communication, in which the computing devices are connected by a network. The method includes creating a session ID and establishing a received bytes counter and a sent bytes counter, waiting for the establishment of a network connection, sending the created session ID to a computing device, reading the computing device's Session ID, determining whether the computing device's session ID is different from its earlier value and, if so, closing the network connection, and if no, sending the value of sent bytes counter and the value of received bytes counter to the computing device, and awaiting for either incoming or outgoing data.

### CROSS-REFERENCE TO RELATED APPLICATIONS

This application claims priority to and benefit of U.S. Provisional Patent Application No. 62/259,271 filed on Nov. 24, 2015 and U.S. Provisional Patent Application No. 62/200,842 filed on Aug. 4, 2015, the entire contents of each of which are hereby incorporated by reference herein in their entirety.

### TECHNICAL FIELD

The present disclosure generally relates to the operation of data networks, and more particularly, to systems and methods for pairing computing devices for communication.

### DESCRIPTION OF RELATED ART

In recent years, the use of electronic devices such as smartphones, tablet computers, personal computers, and the like has become widespread. In parallel, advances in technology have resulted in the development and deployment of extensive data networks. These networks include both public data networks, such as the Internet, and specialized networks, such as wireless telecommunication networks. Users of these networks have the ability to access a wide variety of information and services that are available as network resources.

One example where there is an increasing demand for network resources is in wireless network environments. In wireless environments, a variety of wireless devices, such as wireless telephones, personal digital assistants (PDAs), and paging devices, communicate over a wireless network. The wireless network may also include network servers that operate to provide various network resources to the wireless devices. Furthermore, the wireless networks may also be coupled to a public network, such as the Internet, so that resources on the public network may be made available to the wireless devices on the wireless network.

The Internet protocol suite is the computer networking model and set of communications protocols used on the Internet and similar computer networks. It is commonly known as TCP/IP, because its most important protocols, the Transmission Control Protocol (TCP) and the Internet Protocol (IP) were the first networking protocols defined during its development.

TCP/IP provides end-to-end data communication specifying how data should be packetized, addressed, transmitted, routed and received. This functionality is organized into four abstraction layers which are used to sort all related protocols according to the scope of networking involved. From lowest to highest, the layers are the link layer, containing communication methods for data that remains within a single network segment (link); the internet layer, connecting independent networks, thus providing internetworking; the transport layer handling host-to-host communication; and the application layer, which provides process-to-process data exchange for applications.

Like TCP/IP, the persistent connection consists of a reliable stream pair, one input stream and one output stream. Whenever a network interruption causes the TCP/IP connection to fail, a new TCP/IP connection is opened as soon as reasonably possible, and the persistent connection resumes. The connection may be re-established either in response to re-establishment of network connectivity (for example, if the operating system provides notification of such events), or, if such notifications are not available, by periodic retries, perhaps with exponentially increasing delays between successive attempts.

The duration of the communication lapse may be as short as a few seconds, or as long as several years. The consumer of this system may be informed of the communication lapse, but as long as neither device began a new session, the lapse has no effect on the continuity or integrity of data streaming over the persistent connection.

By the nature of the TCP/IP protocol, whenever a connection fails, it is unclear how much of the transmitted data was received by the peer. Therefore, it is of a particular interest a system and method capable of pairing computing devices for communication, in which there is a constant monitoring of which data has been sent and which data has been received by the computer devices.

### BRIEF SUMMARY

To eliminate the limitations of the related art, the present disclosure proposes a system for periodic acknowledgments embedded in the data streams.

Specifically, the present disclosure describes a method and system for pairing computing devices for communication, in which the computing devices are connected by a network. The method comprising the steps of creating a session ID and establishing a received bytes counter and a sent bytes counter, waiting for the establishment of a network connection, sending the created session ID to a computing device, reading the computing device's Session ID. The present disclosure further comprises determining whether the computing device's session ID is different from its earlier value and, if so, closing the network connection, and if no, sending the value of sent bytes counter and the value of received bytes counter to the computing device. In addition, the method further comprises awaiting for either incoming or outgoing data and, if outgoing data is detected, sending a chunk of outgoing data to the computing device and, if incoming data is detected, reading the chunk and adding the chunk size to the received bytes counter, and reading the number of bytes received and adding said number to the sent bytes counter.

Systems, methods, and computer-readable media are equally suitable for pairing computing devices for communication in the manner described in the present disclosure.

### BRIEF DESCRIPTION OF THE DRAWINGS

The present disclosure is explained in greater detail below on the basis of figures. Shown therein are:

FIG. 1 describes the structure of TCP/IP stream according to an embodiment of the present disclosure.

FIG. 2 describes a flow diagram of a method of interaction between peers according to an embodiment of the present disclosure.

### DETAILED DESCRIPTION

In embodiments described below, pairs of computing devices communicate persistently despite a non-persistent underlying network layer. Communication is transmitted over a bidirectional stream akin to a Transmission Control Protocol/Internet Protocol (TCP/IP) connection. Each device establishes a single “session” at a time. Each pair of devices shares an understanding that their connection will persist for as long as neither device begins a new session. Each device's session embodies a state which has been shaped by the cumulative data that it has received from all of its peers. Tying persistent connections to the lifetime of the sessions enables each device to safely assume that its transmissions have had the desired effects on the states of its peers. This approach helps resolve ambiguity regarding whether certain data need to be retransmitted.

According to the present disclosure, the persistent streams are divided into chunks of a configurable maximum byte size. After each chunk, an acknowledgment of the number of bytes received so far in the other direction is sent. When data is being transmitted in only one direction, zero-length chunks are sent in the other direction so that periodic acknowledgements may be sent. In the event of a communication interruption, only unacknowledged data needs to be retransmitted. As such, a robust bidirectional data stream is established, with a lifetime tied to the application's execution, which survives indefinitely during network outages.

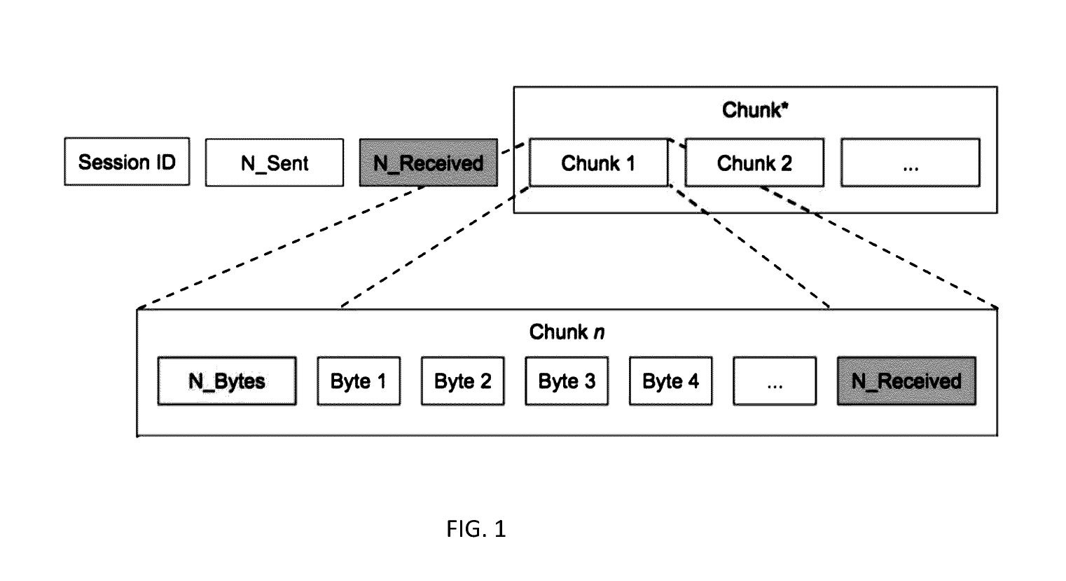

With reference to FIG. 1, the content of each TCP/IP stream is structured as follows:

STREAM = SESSION_ID N_SENT N_RECEIVED CHUNK*
SESSION_ID = <unique fixed-length identifier>
N_SENT = <unsigned_64_bit_int>
N_RECEIVED = <unsigned_64_bit_int>
CHUNK = N_BYTES <byte>* N_RECEIVED
N_BYTES = <unsigned_16_bit_int>

According to the illustrative embodiment of the present disclosure, N_RECEIVED and N_SENT are variables that represent the total number of bytes that have been received and sent on the persistent connection, respectively, counting from the last time that either device began a new session. The variables N_RECEIVED and N_SENT are mere example of counters to account the bytes received and bytes transmitted. A person skilled in the art would understand that any other variable name or means to account data could be used according to the teachings of the present disclosure.

Whenever a device begins a new session, the device creates a unique session ID, sets the counters N_RECEIVED and N_SENT to zero, then establishes a new TCP/IP connection.

Whenever a device encounters a new session ID for a peer with whom it had previously been communicating, it informs the system consumer that a new session has begun, and it resets N_RECEIVED and N_SENT to zero. It is important to note that the preferred embodiments of the present disclosure are applied to peer-to-peer connection, but any other form of network connection between two or more computing devices are encompassed by the teachings of the present disclosure.

According to an alternative embodiment of the present disclosure, either stream may optionally contain header data that precedes the above protocol data.

Embedding acknowledgements in the TCP/IP protocol is inherently redundant since TCP/IP already employs acknowledgment packets in order to implement the sliding window protocol upon which it is based. Therefore, in another embodiment, User Datagram Protocol (UDP) is used as the underlying protocol and an augmented form of TCP/IP is implemented, but eliminating the concept of disconnection at the network layer. Rather, disconnection would only occur when one or both peers explicitly initiates a new session.

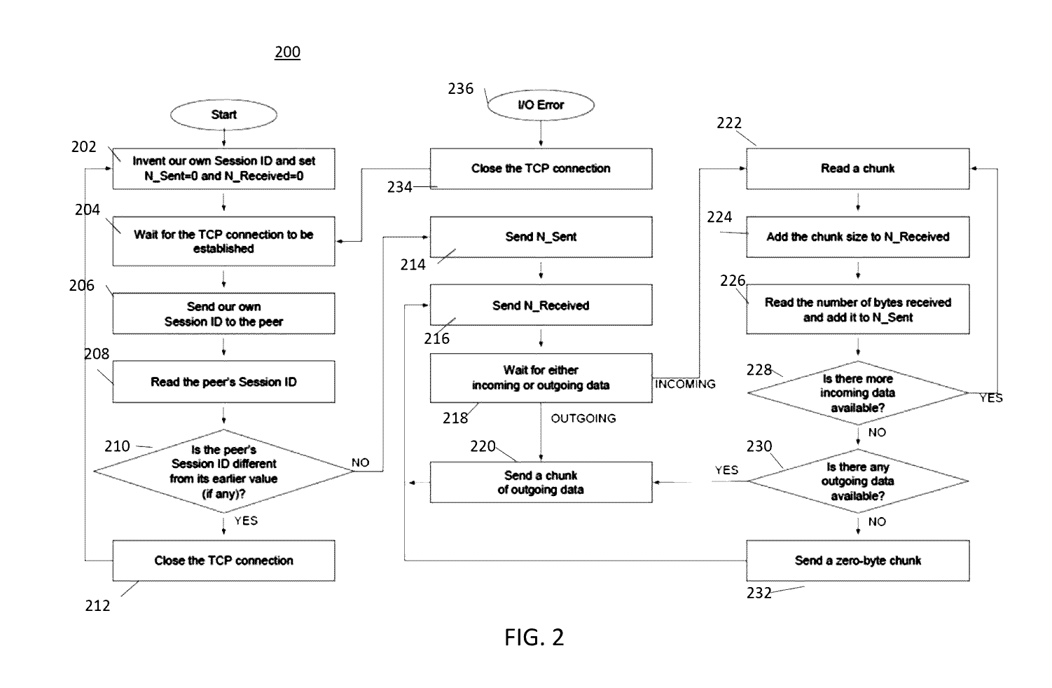

FIG. 2 is a flow diagram of a method 200 of interaction between peers, according to the preferred embodiment of the present disclosure. In an embodiment, a Session ID is created and counters N_Sent=0 and N_Received=0 are set at step 202. Then, a TCP connection to be established is waited on at step 204. The created Session ID is then sent to the peer at step 206. Next, the peer's Session ID is read at step 208. A determination is then made as to whether the peer's Session ID is different from its earlier value, if any, at step 210. If so, the TCP connection is then closed at step 212 and the method 200 iterates at step 202.

If the peer's Session ID is not different from its earlier value, then N_Sent is sent to the peer at step 214 and N_Received is sent to the peer at step 216. Next, the system waits for either incoming or outgoing data at step 218. If outgoing data is detected, a chunk of outgoing data is sent to the peer at step 220. If incoming data is detected, the chunk is read by the system at step 222, the chunk size is added to N_Received at step 224, and the number of bytes received is read and is added to N_Sent at step 226.

Next, a determination is made as to whether more incoming data is available at step 228. If so, the method 200 iterates at step 222 where the chunk is read. If not, a determination is made as to whether more outgoing data is available at step 230. If so, the method 200 iterates at step 220 where the chunk of outgoing data is sent to the peer. If not, the method 200 sends a zero-byte chunk to the peer at step 232 and the method iterates at step 216, where N_Received is sent to the peer.

In an embodiment, in an event of an input/output error at step 236, the TCP connection is closed at step 234 and then method 200 iterates at step 204, where a TCP connection is waited on to be established.

The example embodiments described herein may be implemented using hardware, software or any combination thereof and may be implemented in one or more computer systems or other processing systems. Additionally, one or more of the steps described in the example embodiments herein may be implemented, at least in part, by machines. Examples of machines that may be useful for performing the operations of the example embodiments herein include general purpose digital computers, specially-programmed computers, desktop computers, server computers, client computers, portable computers, mobile communication devices, tablets, and/or similar devices.

For instance, one illustrative example system for performing the operations of the embodiments herein may include one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage.

The system may also include software resident on a storage media (e.g., a disk drive or memory card), which, when executed, directs the microprocessor(s) in performing transmission and reception functions. The software may run on an operating system stored on the storage media, such as, for example, UNIX or Windows (e.g., NT, XP, Vista), Linux, and the like, and can adhere to various protocols such as the Ethernet, ATM, TCP/IP protocols and/or other connection or connectionless protocols.

As is well known in the art, microprocessors can run different operating systems, and can contain different types of software, each type being devoted to a different function, such as handling and managing data/information from a particular source, or transforming data/information from one format into another format. The embodiments described herein are not to be construed as being limited for use with any particular type of server computer, and that any other suitable type of device for facilitating the exchange and storage of information may be employed instead.

Software embodiments of the illustrative example embodiments presented herein may be provided as a computer program product, or software, that may include an article of manufacture on a machine-accessible or non-transitory computer-readable medium (also referred to as “machine-readable medium”) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions.

The techniques described herein are not limited to any particular software configuration. They may be applicable in any computing or processing environment. The terms “machine-accessible medium”, “machine-readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments have been described above, it should be understood that they have been presented by way of example, and not limitation. It will be apparent to persons skilled in the relevant art(s) that various changes in form and detail can be made therein.

1. A method for pairing computing devices for communication, in which the computing devices are connected by a network, the method comprising:
creating a session ID and establishing a received bytes counter and a sent bytes counter;
waiting for the establishment of a network connection;
sending the created session ID to a computing device;
reading the computing device's Session ID;
determining whether the computing device's session ID is different from its earlier value;
if so, closing the network connection;
if the computing device's Session ID is not different from its earlier value, sending the value of sent bytes counter and the value of received bytes counter to the computing device;
awaiting either incoming or outgoing data;
if outgoing data is detected, sending a chunk of the outgoing data to the computing device; and
if incoming data is detected, reading the chunk and adding the chunk size to the received bytes counter, and reading the number of bytes received and adding the number to the sent bytes counter.

2. The method according to claim 1, further comprising:
after detecting income data, determining whether more incoming data is available:
if so, reading the chunk and adding the chunk size to the received bytes counter, and reading the number of bytes received and adding the number to the sent bytes counter;
if not, determining whether more outgoing data is available.

3. The method according to claim 2, further comprising:
if more outgoing data is available, sending the chunk of the outgoing data to the computing device;
if not, sending a zero-byte chunk to the computing device and sending the value of received bytes counter to the computing device.

4. The method according to claim 1, wherein in an event of an input/output error, the method further comprises:
closing the network connection, and
waiting for a network connection to be established.

5. The method according to claim 1, wherein the network is a peer-to-peer network.

6. The method according to claim 1, wherein the received bytes counter and the sent bytes counter are initially established with zero value.

7. The method according to claim 1, wherein the data contain header data that precedes the protocol data.

8. A system for pairing computing devices for communication, in which the computing devices are connected by a network, the system comprising:
means for creating a session ID and establishing a received bytes counter and a sent bytes counter;
means for waiting for the establishment of a network connection;
means for sending the created Session ID to a computing device;
means for reading the computing device's Session ID;
means for determining whether the computing device's session ID is different from its earlier value;
means for, in case computing device's session ID is different from its earlier value, closing the network connection;
means for, if the computing device's Session ID is not different from its earlier value, sending the value of sent bytes counter and the value of received bytes counter to the computing device;
means for awaiting for either incoming or outgoing data;
means for, if outgoing data is detected, sending a chunk of outgoing data to the computing device;
means for, if incoming data is detected, reading the chunk and adding the chunk size to received bytes counter, and reading the number of bytes received and adding said number to the sent bytes counter.

9. The system according to claim 8, further comprising:
means for, after detecting income data, determining whether more incoming data is available:
means for, if there is more incoming data available, reading the chunk and adding the chunk size to the received bytes counter, and reading the number of bytes received and adding said number to the sent bytes counter;
means for, if there is no more incoming data available, determining whether more outgoing data is available.

10. The system according to claim 9, further comprising:
means for, if there is more outgoing data available, sending the chunk of outgoing data to the computing device;
means for, if there is no more outgoing data available, sending a zero-byte chunk to the computing device and sending the value of received bytes counter to the computing device.

11. The system according to claim 8, wherein in an event of an input/output error, the system further comprises:
means for closing the network connection,
means for waiting a network connection to be established.

12. The system according to claim 8, wherein the network is a peer-to-peer network.

13. The system according to claim 8, wherein the received bytes counter and the sent bytes counter are initially established with zero value.

14. The system according to claim 8, wherein the data contain header data that precedes the protocol data.

15. A computer product program for pairing computing devices connected by a network for communication, wherein when read by a computer, the computer performs the following operations:
creating a session ID and establishing a received bytes counter and a sent bytes counter;
waiting for the establishment of a network connection;
sending the created Session ID to a computing device;
reading the computing device's session ID;
determining whether the computing device's session ID is different from its earlier value;
if so, closing the network connection;
if the computing device's Session ID is not different from its earlier value, sending the value of sent bytes counter and the value of received bytes counter to the computing device;
awaiting for either incoming or outgoing data;
if outgoing data is detected, sending a chunk of outgoing data to the computing device;
if incoming data is detected, reading the chunk and adding the chunk size to received bytes counter, and reading the number of bytes received and adding the number to the sent bytes counter.

16. The computer product program, according to claim 15, further comprising:
after detecting income data, determining whether more incoming data is available:
if more incoming data is available, reading the chunk and adding the chunk size to the received bytes counter, and reading the number of bytes received and adding said number to the sent bytes counter;
if more incoming data is not available, determining whether more outgoing data is available.

17. The computer product program, according to claim 16, further comprising:
if there is more outgoing available, sending the chunk of outgoing data to the computing device;
if not, sending a zero-byte chunk to the computing device and sending the value of received bytes counter to the computing device.

18. The computer product program, according to claim 15, wherein in an event of an input/output error, further comprises:
closing the network connection, and
waiting for a network connection to be established.

19. The computer product program, according to claim 15, wherein the received bytes counter and the sent bytes counter are initially established with zero value.

20. The computer product program, according to claim 15, wherein the data contain header data that precedes the protocol data.
